(19) United States
(12) Patent Application Publication
(10) Pub. No.: US 2025/0236120 A1
(43) Pub. Date: Jul. 24, 2025

(54) PRINTING APPARATUS, METHOD OF CONTROLLING A PRINTING APPARATUS AND STORAGE MEDIUM

(71) Applicant: CANON KABUSHIKI KAISHA, Tokyo (JP)

(72) Inventor: ERIKA OISHI, Kanagawa (JP)

(21) Appl. No.: 19/033,991

(22) Filed: Jan. 22, 2025

(30) Foreign Application Priority Data
Jan. 24, 2024 (JP) 2024-008572

(51) Int. Cl. B41J 11/00

(52) U.S. Cl. CPC B41J 11/007; B41J 11/002

(57) ABSTRACT

A printing apparatus capable of improving throughput while securing an appropriate drying time is provided. In a case where an area in which it is not necessary to perform printing of a printing medium is located at a position at which a printing unit can perform printing, on a condition that an image printed by the printing unit does not exist between a drying unit and the printing unit, a control unit performs first control to cause a conveyance unit to convey a printing medium at a first conveyance speed higher than a predetermined conveyance speed and on a condition that an image printed by the printing unit exists between the drying unit and the printing unit, the control unit performs second control to cause the conveyance unit to convey a printing medium at a second conveyance speed slower than the first conveyance speed.

### BACKGROUND

### Field of the Disclosure

The present disclosure relates to a printing apparatus and a method of controlling a printing apparatus.

### Description of the Related Art

Japanese Patent Laid-Open No. H07-214767 has disclosed an ink jet print apparatus (printing apparatus) in which a printing unit and a drying unit are arranged in a conveyance path of a printing medium. According to this configuration, after printing is performed, the ink appended to the printing medium is dried efficiently by the drying unit.

Japanese Patent Laid-Open No. 2013-28090 has disclosed a printing apparatus that conveys a sheet at a speed higher than a normal speed in a case where there exists a blank area in which printing is not performed for a sheet (printing medium) in the configuration in which a printing unit and a drying unit are arranged in a conveyance path of the printing medium. According to this configuration, the improvement of throughput in a case where a blank area exists on a sheet is implemented.

However, in a case where a sheet is conveyed at a speed higher than a normal speed as in Japanese Patent Laid-Open No. 2013-28090, throughput is improved, but it may happen sometimes that drying by the drying unit is insufficient in the printing medium. Neither Japanese Patent Laid-Open No. H07-214767 nor Japanese Patent Laid-Open No. 2013-28090 refers to securing an appropriate drying time in a case where the conveyance speed changes in accordance with the situation.

### SUMMARY

An aspect of the present disclosure is to provide a printing apparatus capable of improving throughput while securing an appropriate drying time.

The printing apparatus according to the present disclosure is a printing apparatus including: a conveyance unit configured to convey a printing medium in a conveyance direction; a printing unit configured to print an image by appending liquid to a printing medium to be conveyed by the conveyance unit; a drying unit provided on the downstream side of the printing unit in a conveyance path of a printing medium and configured to dry liquid appended by the printing unit; and a control unit configured to alternately perform an operation to cause the conveyance unit to convey a printing medium at a predetermined conveyance speed and an operation to cause the printing unit to perform printing, wherein in a case where an area in which it is not necessary to perform printing of a printing medium is located at a position at which the printing unit can perform printing: on a condition that an image printed by the printing unit does not exist between the drying unit and the printing unit, the control unit performs first control to cause the conveyance unit to convey a printing medium at a first conveyance speed higher than the predetermined conveyance speed; and on a condition that an image printed by the printing unit exists between the drying unit and the printing unit, the control unit performs second control to cause the conveyance unit to convey a printing medium at a second conveyance speed slower than the first conveyance speed.

Further features of the present disclosure will become apparent from the following description of exemplary embodiments with reference to the attached drawings.

### BRIEF DESCRIPTION OF THE DRAWINGS

FIG. 1 is a schematic diagram showing one example of a printing system according to one more aspects of the present disclosure;

FIG. 2 is a block diagram showing one example of a configuration of a printing apparatus according to one more aspects of the present disclosure;

FIG. 3 is an external appearance diagram of the printing apparatus;

FIG. 4 is a cross-sectional schematic diagram showing one example of a drying unit according to one more aspects of the present disclosure;

FIG. 5 is a diagram showing one example of a menu screen according to one more aspects of the present disclosure;

FIG. 6 is a diagram showing one example of a selection screen that can be applied to the present embodiment;

FIG. 7 is a perspective diagram showing an internal structure of the printing apparatus;

FIG. 8 is a schematic diagram showing a cross section of a conveyance configuration according to one more aspects of the present disclosure;

FIG. 9 is a flowchart showing processing in a case where a printing operation according to one more aspects of the present disclosure is performed;

FIG. 10 is a diagram showing one example of a guide screen according to one more aspects of the present disclosure;

FIG. 11 is a flowchart showing details of processing according to one more aspects of the present disclosure; and

FIG. 12 is a diagram showing one example of a check screen according to one more aspects of the present disclosure.

### DESCRIPTION OF THE EMBODIMENTS

### First Embodiment

### Printing System 100

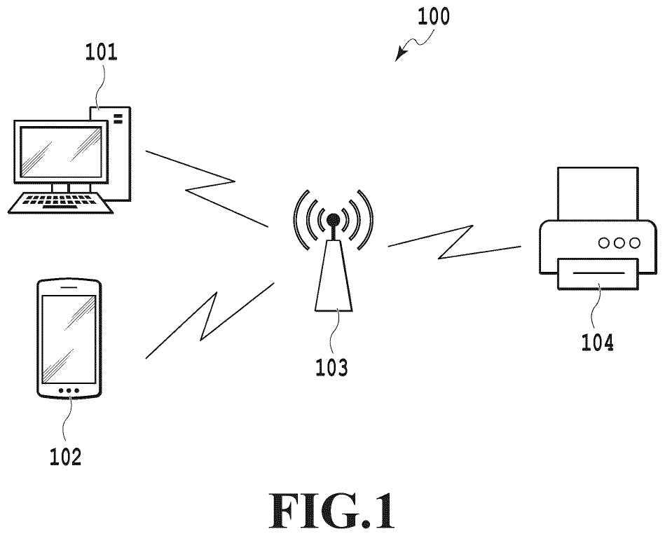

FIG. 1 is a schematic diagram showing one example of a printing system 100 that can be applied to the present embodiment.

In the present disclosure, “printing” means not only forming significant information (for example, a character, graphics or the like made visual so that a human being can percept them visually). “Printing” also means forming meaningless information. Further, in the present disclosure, “printing” also means widely forming an image, a pattern, a structure, a combination of these, or the like on a printing medium, or modifying a medium.

“Printing medium” includes not only paper used by a general printing apparatus but also what can receive ink, such as cloth, plastic film, metal plate, glass, ceramics, resin, wood, and leather. The printing medium may be any medium on which an image can be formed by causing ink droplets to land thereon. For example, it is possible to use various materials and aspects, such as paper, cloth, optical disc label surface, plastic sheet, OHP sheet, and envelope.

As shown in FIG. 1, the printing system 100 in the present embodiment includes external devices (for example, a personal computer 101, a smartphone 102 and the like), a LAN unit 103, and a printing apparatus 104.

The connection between the printing apparatus 104 and the external device is made via the LAN unit 103 for connecting to a server (not shown schematically). Specifically, via an interface (for example, USB) of the external device and a network, the printing apparatus 104 and the external device are connected. Image data is transferred from the external device to the printing apparatus 104 via the LAN unit 103. The LAN unit 103 may be wired or wireless and is not limited as long as its communication method enables transmission and reception of data. The LAN unit 103 may be provided inside the printing apparatus 104 or may be provided outside the printing apparatus 104 independently of the printing apparatus 104.

### Printing Apparatus 104

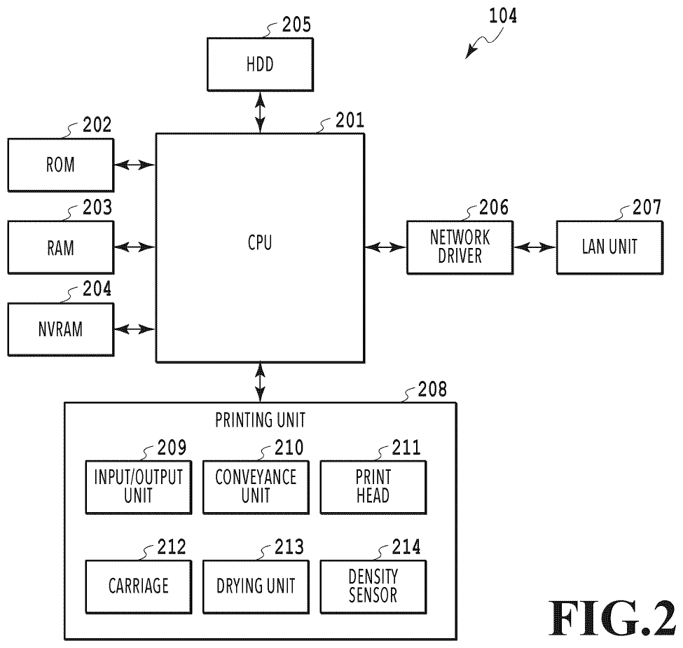

FIG. 2 is a block diagram showing one example of the configuration of the printing apparatus 104 that can be applied to the present embodiment.

As shown in FIG. 2, the printing apparatus 104 comprises a CPU 201, a ROM 202, a RAM 203, an NVRAM (Non-Volatile RAM) 204, and an HDD (Hard Disk Drive) 205. In the HDD 205, the image data of an image that is printed by a printing unit 208 is stored.

The printing apparatus 104 comprises a network driver 206 and a LAN unit 207. The printing apparatus 104 comprises the printing unit 208 configured to perform printing by being controlled by the CPU 201 as a control unit.

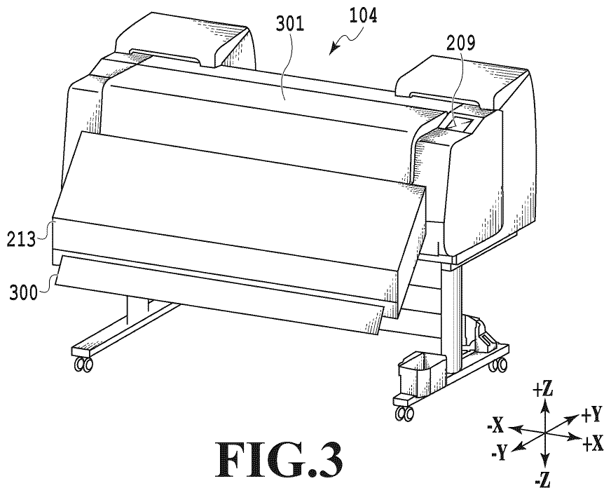

The printing unit 208 includes an input/output unit 209 configured to function as a user interface. As examples of the user interface in the input/output unit 209, there are an LCD, an LED, a key, a touch panel and the like. The printing unit 208 includes a conveyance unit 210 configured to convey a printing medium 300 (see FIG. 3), a print head 211 configured to append liquid to a printing medium, a carriage 212 capable of attaching and detaching the print head 211, and a drying unit 213 configured to dry a printing medium. The printing unit 208 includes a density sensor 214 capable of detecting a difference in density on the printing surface of a printing medium.

In the present embodiment, the function of the information processing apparatus for performing processing to determine a printing medium that is used, which will be described later, is mounted in the printing apparatus 104. In the ROM 202, a control execution code (program) of the printing apparatus 104 is stored. In the RAM 203, image data that is printed in the control execution of the printing apparatus 104 is stored temporarily.

In the NVRAM 204 (that is, nonvolatile memory), information relating to printing of various pieces of data necessary for maintenance of the printing apparatus 104 and images for performing printing is stored. As examples of information that is stored in the NVRAM 204, there are the minimum time in which it is possible to appropriately dry the printing medium 300 (not shown schematically in FIG. 2), the maximum time and the like.

The drying time of the printing medium 300 is determined approximately in accordance with the printing conditions, the environmental conditions and the like. In the NVRAM 204, the printing conditions, the environmental conditions and the like for appropriately drying the printing medium 300 are also stored. For example, the drying time in accordance with the type of the printing medium 300, the printing mode, the ambient temperature (environmental temperature) of the printing apparatus 104, and the humidity (environmental humidity) is stored in the NVRAM 204.

It is possible for the LAN unit 207 to connect with the server via the interface of an external device, a network and the like. The LAN unit 207 performs transmission and reception of execution instructions and data with an external device and the server via the LAN unit 103 (see FIG. 1). For example, in a case where the printing unit 208 performs printing, the instruction to perform printing and the job including image data are transferred from an external device via the LAN unit 103 (see FIG. 1). Of course, the job may be input directly by a user via the input/output unit 209.

FIG. 3 is an external appearance perspective diagram of the printing apparatus 104.

As shown in FIG. 3, the printing apparatus 104 comprises the drying unit 213. Inside the drying unit 213, the printing medium 300 to which ink has been appended is heated. By the printing medium 300 being heated, the ink cures and the ink fixes to the printing surface of the printing medium 300. Although not shown in FIG. 3, at the deeper portion of the drying unit 213, the print head 211 configured to print an image on a printing medium by ejecting ink, a conveyance unit configured to convey the printing medium 300 in the conveyance direction (Y-direction), and the like are comprised.

In a case of the serial ink jet printing apparatus, the printing scan by the print head 211 and the conveyance operation of a printing medium are performed alternately. In this case, the speed of the printing scan and the time necessary for the printing of the conveyance distance (that is, unit area) of the conveyance operation are different in accordance with the printing mode. Consequently, the time taken for the area in which an image has been printed by the print head 211 to pass the drying unit (that is, the drying time) is also different in accordance with the printing mode.

In a case where the drying time is shorter than the minimum time in which it is possible to appropriately dry the printing medium 300, the ink cannot be dried sufficiently, and therefore, there is a possibility that a variety of troubles may be caused, such as that the ink is seen from the reverse side. On the other hand, in a case where the drying time of the printing medium 300 is longer than the maximum time in which it is possible to appropriately dry the printing medium 300, heating will be excessive, and therefore, there arises a possibility that the image quality is reduced and the like. Consequently, in the present embodiment, control is performed so that the drying time of the printing medium 300 becomes the time between the minimum time and the maximum time in both of which it is possible to appropriately dry the printing medium 300.

In the state where appropriate drying has been performed and the ink has fixed, the printing medium 300 is discharged from the drying unit 213.

Further, the printing apparatus 104 comprises an upper cover 301 configured to cover the top of the printing apparatus 104. On the top of the printing apparatus 104, the input/output unit 209 is also provided.

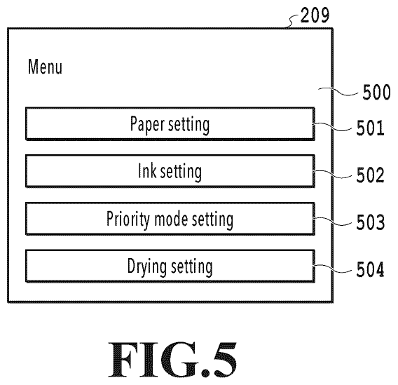

In the present embodiment, the input/output unit 209 is an operation panel. On the display of the input/output unit 209, the amount of remaining ink, candidates of the type of the printing medium 300, and the like are displayed. It is possible for a user to select the type of the printing medium 300, perform the setting of printing, and so on by operating keys and the like included on a Menu screen 500 (see FIG. 5) displayed on the display of the input/output unit 209.

### Drying Unit 213

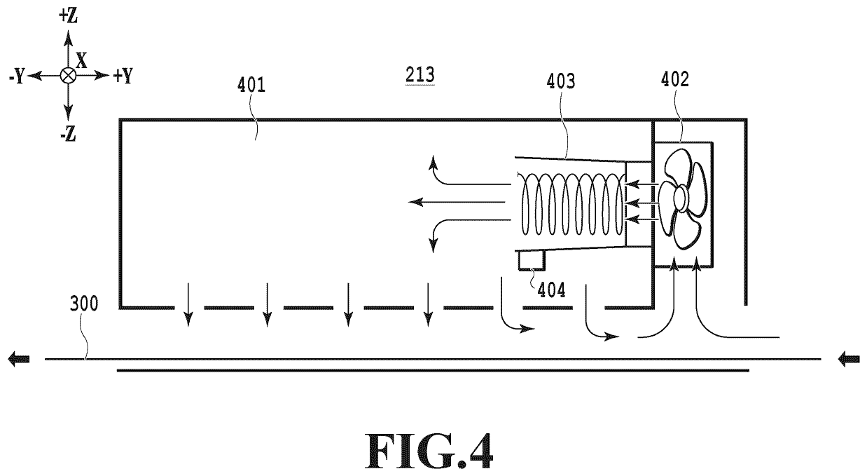

FIG. 4 is a cross-sectional schematic diagram showing one example of the drying unit 213 that can be applied to the present embodiment.

As shown in FIG. 4, the drying unit 213 comprises a chamber 401, axial flow-type blower fan 402, and a coil-type heater 403 provided inside the chamber 401. To the heater 403, a temperature sensor 404 for detecting the temperature of the heater 403 is mounted.

In the chamber 401, an inlet port for taking in the atmosphere to the inside from the outside of the chamber 401 and a plurality of air outlets for blowing drying air from the inside of the chamber 401 to the outside are provided.

Outside the inlet port, the blower fan 402 is mounted. By the blower fan 402 rotating, the atmosphere is taken in to the inside from the outside of the chamber 401 through the inlet port. Inside the chamber 401, the atmosphere that has been taken in is heated by the heater 403. The temperature of the heater 403 is detected by the temperature sensor 404 and by the detected temperature being fed back appropriately, stable temperature control is performed.

Under the temperature control such as this, inside the chamber 401, the atmosphere that has been taken in is heated until a predetermined temperature is reached. By the blower fan 402 continuing to rotate, the atmosphere that has been taken in to the inside the chamber 401 becomes drying air at a predetermined temperature and brown to the printing medium 300 from the air outlet. The blowing of the drying air such as this contributes to the drying and fixing of the ink appended to the printing medium 300.

In the present embodiment, it is possible to use the latex ink as ink. By applying heat to the latex ink, moisture evaporates and the latex resin dissolves and mingles with pigment and a film is formed on the printing surface of the printing medium 300 and the film cures. In a case where the general aqueous ink is used, the printing medium 300 needs an ink receiving layer for receiving ink and suppressing blurring. In contrast to this, in a case where the latex ink is used, it is made possible to perform printing also for the printing medium 300 not comprising the ink receiving layer.

### Menu Screen 500

FIG. 5 is a diagram showing one example of the Menu screen 500 that can be applied to the present embodiment.

As shown in FIG. 5, on the input/output unit 209, the Menu screen 500 is displayed. The Menu screen 500 includes a “Paper setting” button 501, an “Ink setting” button 502, a “Priority mode setting” button 503, and a “Drying setting” button 504.

By the “Paper setting” button 501 being pressed down, on the input/output unit 209, a paper selection screen (not shown schematically) for inputting the type of the printing medium 300 (not shown schematically in FIG. 5) is displayed. It is made possible for a user to input the type of the paper (printing medium 300) that is the target of printing via the paper selection screen.

For example, in a case where water-fastness paper is selected via the paper selection screen, “skip feed” to be described later is not performed. Although details will be described later, “skip feed” is to convey the printing medium 300 at a speed higher than the speed set in advance. In a case where printing is performed for the water-fastness paper, it is necessary to secure a sufficient drying time. The reason is that the water-fastness paper is hard to absorb ink compared to paper other than the water-fastness paper. Consequently, in a case where printing is performed for the water-fastness paper, on a condition that the conveyance speed is increased and becomes higher than the conveyance speed set in advance, there is a possibility that it is not possible to secure a sufficient drying time. Because of this, in a case where the water-fastness paper is selected, “skip feed” is not performed.

However, after the entire printing area (that is, image) in which printing has been performed on the printing medium 300 has passed the drying unit 213 (not shown schematically in FIG. 5), “skip feed” may be performed. The reason is that at this timing, the drying for the image printed on the printing medium 300 is completed and the possibility that the state is such that the ink has fixed to the printing medium 300 is comparatively strong.

That is, even skip feed is performed for the margin of the printing medium 300 at this timing, there is almost no influence on the image quality. Consequently, after the entire image printed on the printing medium 300 has passed the drying unit 213, “skip feed” may be performed.

By the “Ink setting” button 502 being pressed down, an ink selection screen (not shown schematically) for inputting the type of ink to be appended to the printing medium 300 (not shown schematically in FIG. 5) is displayed. It is made possible for a user to input the type of ink to be used for printing via the ink selection screen. The drying time of the printing medium 300 is determined with various elements being taken into consideration and those elements also include the type of ink. By the type of ink being input via the ink selection screen, it is made possible for the CPU 201 (see FIG. 2) to obtain the type of ink in a case of determining the drying time of the printing medium 300.

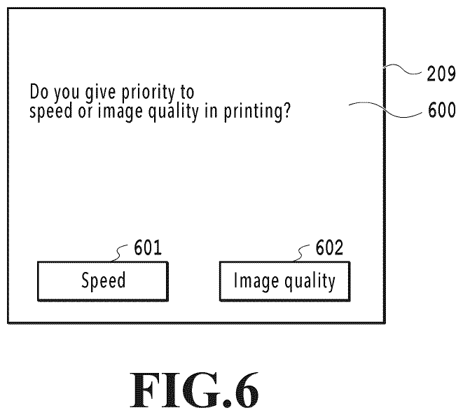

By the “Priority mode setting” button 503 being pressed down, a selection screen 600 (see FIG. 6) is displayed on the input/output unit 209.

### Selection Screen 600

FIG. 6 is a diagram showing one example of the selection screen 600 that can be applied to the present embodiment.

As shown in FIG. 6, the selection screen 600 that is displayed on the input/output unit 209 includes a “Speed” button 601 and an “Image quality” button 602. By pressing down the “Speed” button 601 or the “Image quality” button 602, it is possible for a user to select to give priority to the speed of printing or the image quality as regards printing quality.

In a case where the Speed” button 601 is pressed down by a user, priority is given to the speed of printing over the image quality. The speed of printing in a case where the “Speed” button 601 is pressed down is higher than the speed of printing in a case where the “Image quality” button 602 is pressed down. However, the image quality in a case where the “Speed” button 601 is pressed down is lower than the image quality in a case where the “Image quality” button 602 is pressed down. As the printing mode in a case where the “Speed” button 601 is pressed down, there is one-pass printing completing an image for the unit area by one-pass printing scan.

In a case where the “Image quality” button 602 is pressed down by a user, priority is given to the image quality over the printing speed. Specifically, in a case where the “Image quality” button 602 is pressed down, “skip feed” is not performed. The reason is that in a case where “skip feed” is performed in a situation in which priority is given to the image quality over the printing speed, the drying time cannot be secured sufficiently, and therefore, there is a possibility that, for example, an event occurs, such as that ink is seen from the reverse side, and a desired image quality cannot be obtained.

Further, the image quality in a case where the “Image quality” button 602 is pressed down is improved and becomes higher than that in a case where the “Speed” button 601 is pressed down. However, the speed of printing in a case where the “Image quality” button 602 is pressed down is reduced and becomes lower than the speed of printing in a case where the “Speed” button 601 is pressed down. As the printing mode in a case where the “Image quality” button 602 is pressed down, for example, there is multipass printing completing an image for the unit area by two times or more times of printing scan.

As above, the printing apparatus 104 (not shown schematically in FIG. 6) is configured to as to enable a user to arbitrarily switch between giving priority to speed over image quality and giving priority to image quality over speed. The CPU 201 sets an appropriate printing mode based on contents and the like input via the Menu screen 500.

In the following, with reference to FIG. 5 again, the explanation of the Menu screen 500 is continued.

By the “Drying setting” button 504 being pressed down, a drying setting screen (not shown schematically) relating to drying of a printing medium is displayed on the input/output unit 209. The drying time of the printing medium 300 is calculated by multiplying the minimum drying time and the maximum drying time, which are set in advance for each type of the printing medium 300, by an offset value in accordance with the amount of appended ink and temperature. On the other hand, there is a case where a user desires to manually change the calculated drying time. In the case such as that, it is possible for a user to manually input and set an arbitrary drying time via the drying setting screen (not shown schematically).

These buttons described above are merely examples of keys that are displayed on the input/output unit 209. Softkeys other than these may be displayed on the input/output unit 209.

### Internal Structure of Printing Apparatus 104

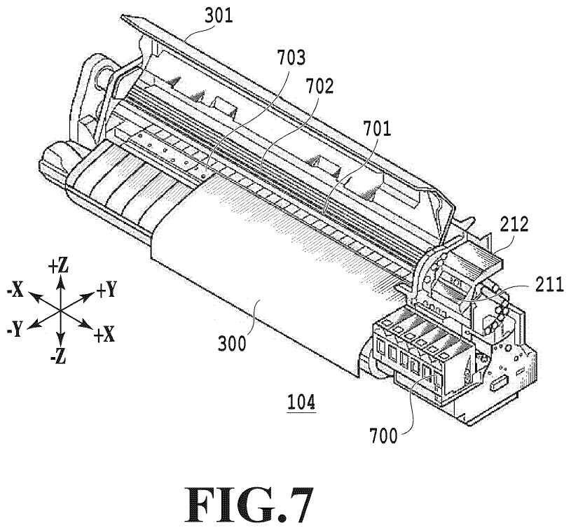

FIG. 7 is a perspective diagram showing the internal structure of the printing unit of the printing apparatus 104. In FIG. 7, the printing apparatus 104 is shown in the state where the upper cover 301 is open.

As shown in FIG. 7, inside the printing apparatus 104, the print head 211 and the carriage 212 are provided. Inside the printing apparatus 104, a liquid storage unit 700 in which liquid is stored, a carriage belt 701 for reciprocating the carriage 212, a shaft 702 configured to support the carriage 212, and a platen 703 configured to support the printing medium 300 are also provided.

The printing apparatus 104 of the present embodiment is a so-called serial printing apparatus. The carriage 212 is supported slidably along the shaft 702 via the carriage belt 701 and caused to reciprocate in the scanning direction (X-direction) intersecting the conveyance direction.

Then, by the print head 211 ejecting ink to the printing surface of the printing medium 300 that is conveyed while the carriage 212 is being caused to reciprocate, printing is performed for the printing medium 300. By the movement in the first half or in the second half of reciprocation of the carriage 212, printing corresponding to one band is performed for the printing medium 300. That is, by the carriage 212 performing a scan, an image corresponding to one band is formed on the printing medium 300. Here, one band means the area in which printing is possible by one-time movement in the first half or in the second half of reciprocation of the print head 211.

Following the above, the printing medium 300 is conveyed by a predetermined amount of conveyance in the conveyance direction by the conveyance unit 210 (see FIG. 2). This predetermined amount of conveyance is made appropriate by the printing mode. Then, while the carriage 212 is being moved again, printing for the next one band is performed. By the repetition of this operation, printing is performed for the printing surface of the printing medium 300.

Further, at the position in opposition to the print head 211, the platen 703 is provided. During the printing operation, the printing medium 300 is supported by the platen 703 from the underside.

In the present embodiment, as the liquid storage unit 700, six ink tanks are provided. In each of the six ink tanks, inks of cyan, magenta, yellow, black, light cyan, and light magenta are stored, respectively.

Further, the ink flow path inside the print head 211 is provided with an energy generation element (electrothermal converting element). By causing a current to flow through the energy generation element and causing the energy generation element to generate heat energy, the ink within the ink flow path is heated and foaming occurs due to film boiling and ink droplets are ejected from the ejection port by the foaming energy at that time.

In the print head 211 of the present embodiment, on the surface in opposition to the printing medium 300, ejection port arrays, not shown schematically, in which a plurality of ejection ports is arranged along the conveyance direction (-Y-direction) of the printing medium 300, are formed in number corresponding to the number of ink colors in the scanning direction (X-direction) of the carriage 212. The carriage 212 may eject inks of the above-described six colors from each ejection port array. As described above, the printing apparatus 104 of the present embodiment is configured so as to be capable of performing full-color printing for the printing medium 300.

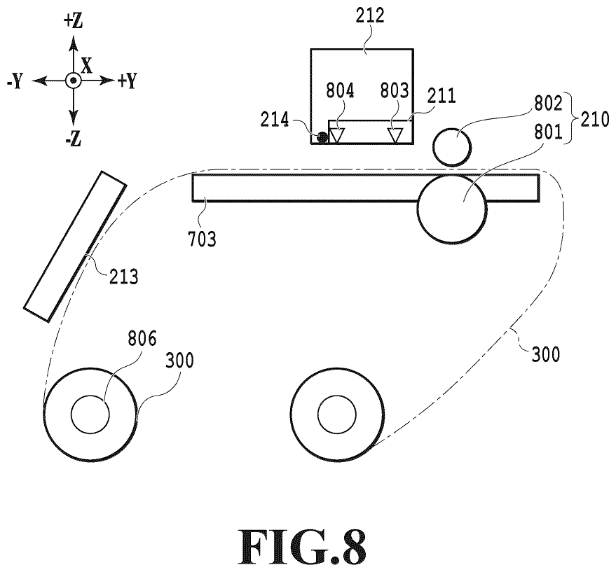

FIG. 8 is a schematic diagram showing a cross section of the conveyance configuration of the printing medium 300 that can be applied to the present embodiment.

In the present disclosure, the side (right side in FIG. 8) of the conveyance path of the printing medium 300 on which the printing medium 300 in the state before printing is performed exists is called the upstream side by taking the print head 211 as a boundary. On the other hand, the side (left side in FIG. 8) on which the printing medium 300 in the state after printing is performed exists is called the downstream side by taking the print head 211 as a boundary.

As shown in FIG. 8, to the upstream side of the conveyance path of the present embodiment, the printing medium 300 in the state where printing is performed is attached. In the present embodiment, as the printing medium 300, continuous paper (more specifically, roll paper) is attached. The drying unit 213 is provided on the downstream side of the print head 211.

The conveyance unit 210 capable of conveying the printing medium 300 includes a first conveyance roller 801 and a second conveyance roller 802. In the state where the printing medium 300 is sandwiched between the first conveyance roller 801 and the second conveyance roller 802, by the first conveyance roller 801 and the second conveyance roller 802 rotating in the directions opposite to each other, the printing medium 300 is conveyed in the conveyance direction (−Y-direction).

A plurality of ejection ports of the print head 211 includes an uppermost stream ejection port 803 provided on the uppermost stream side and a downmost stream ejection port 804 provided on the downmost stream side.

On the carriage 212, the density sensor 214 is mounted. The density sensor 214 detects a difference in density on the printing surface by irradiating the printing surface of the printing medium 300 with LED light of three colors and receiving the reflected light by a photodiode. Specifically, the density sensor 214 detects the difference in density on the printing surface by digitally converting the analog signal received by the photodiode to obtain a density value. In a case where the detection results of the density sensor 214 are larger than a predetermined value, that is, the reflected light is stronger than a predetermined value in intensity, it is possible for the CPU 201 to determine that printing has not been performed in the area. On the other hand, in a case where the detection results of the density sensor 214 are smaller than a predetermined value, that is, the reflected light is weaker than a predetermined value in intensity, it is possible for the CPU 201 to determine that printing has been performed in the area.

In the present embodiment, it is possible to determine whether the area of the printing medium 300 located directly under the print head 211 is the printing area in which printing has been performed by the print head 211 or the blank area in which it is not necessary to perform printing by using the density sensor 214 as described above. However, the method of determining whether an area is the printing area or the blank area is not limited to the method such as this. It is also possible for the CPU 201 to make the determination based on the contents of a received job and the situation of progress of the printing by the print head 211.

The area in which printing has been performed on the printing medium 300 is conveyed toward the drying unit 213. In the drying unit 213, the fixing of ink is performed for the printing medium 300. After the ink has fixed to the printing medium 300, the printing medium 300 is wound by a winding unit 806.

Incidentally, in a case where the printing apparatus 104 to which one piece of roll paper is attached receives a plurality of jobs, for the printing surface of the roll paper, printing and drying are repeated continuously. As a result of that, on the printing surface, a first printing area (first image) to which ink has been appended, a blank area (margin), and a second printing area to which ink has been appended (second image) exist in this order. In this case, on a condition that the blank area exists under the print head 211, it is considered to improve throughput by conveying the printing medium continuously instead of intermittently.

In the present disclosure, the operation to convey the printing medium 300 continuously in a case where the blank area of the printing medium 300 passes under the print head 211 is called “skip feed”. For example, in a case of a print job including many blank areas, throughput is improved by performing skip feed compared to a case where the printing medium 300 is conveyed by intermittent conveyance at all times.

However, even though the blank area is located under the print head 211, in a case where there is an area not having passed the drying unit 213 yet among the printing areas in which printing has been performed by the print head 211, performing skip feed at a high conveyance speed will cause a possibility that the fixing in the above-described printing area becomes insufficient.

On the other hand, in a case where the blank area is located under the print head 211 and all the printing areas (images) in which printing is performed by the print head 211 have already passed the drying unit 213, performing skip feed at a high speed does not affect the image and throughput can be improved.

Consequently, in a case where the blank area is located under the print head 211, the CPU 201 of the present embodiment determines whether or not to perform skip feed based on whether or not the printing area in which printing has been performed by the print head 211 exists between the print head 211 and the drying unit 213.

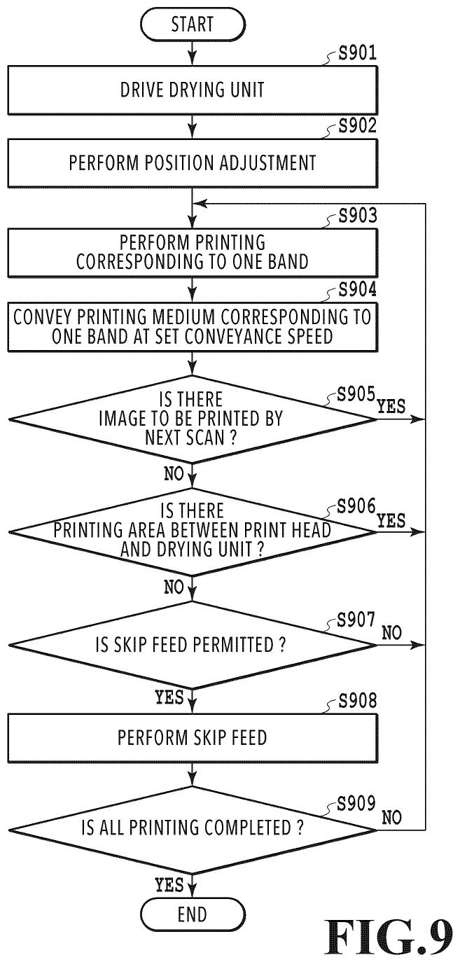

FIG. 9 is a flowchart showing processing that is performed by the CPU 201 (see FIG. 2) in a case where a print job is input to the printing apparatus of the present embodiment. The series of processing shown in the flowchart in FIG. 9 is performed by the CPU 201 loading a program code stored in the ROM 202 (see FIG. 2) onto the RAM 203 (see FIG. 2) and executing the program code.

Part or all of the functions at the steps in FIG. 9 may also be implemented by hardware, such as an ASIC and an electronic circuit. A symbol “S” in the explanation of each piece of processing means that the step is a step in this flowchart (in the following, this is the same in the present disclosure).

In a case where a print job is input, at S901, the CPU 201 drives the drying unit 213 (not shown schematically in FIG. 9). Due to this, the drying unit 213 enters a state where it is possible to perform drying processing for the printing medium 300 (not shown schematically in FIG. 9). In this case, it may also be possible for the CPU 201 to control the blower fan 402 and the heater 403 while observing the detection results of the temperature sensor 404 shown in FIG. 4 based on the type of ink, the type of printing medium, the contents set via the “Drying setting” button 504 (see FIG. 5), and the like. After the completion of the processing at S901, the CPU 201 performs processing at S902.

At S902, the CPU 201 performs position adjustment (so called search) of the printing medium 300 for the print head 211 (not shown schematically in FIG. 9). Specifically, the CPU 201 drives the conveyance unit 210 (not shown schematically in FIG. 9) so that the initial position of the image data indicated by the print job, the starting position of printing on the printing medium 300, and the position of the print head 211 coincide with one another. After the completion of the processing at S902, the CPU 201 performs the processing at S903.

At S903, the CPU 201 performs printing corresponding to one band for the printing medium 300 by driving the print head 211 (not shown schematically in FIG. 9) while causing the carriage 212 to perform a scan. After the completion of the processing at S903, the CPU 201 performs the processing at S904.

At S904, the CPU 201 drives the conveyance unit 210 and conveys the printing medium 300 a distance corresponding to one band at a set conveyance speed.

In the present embodiment, in a case where the area of the printing medium 300 in which an image should be printed is located at the position at which the print head 211 can perform printing, the CPU 201 causes the conveyance unit 210 to convey the printing medium at a predetermined conveyance speed. For example, in a case where one-pass printing is set as the printing mode, the printing medium 300 is conveyed by a distance corresponding to the printing width (distance between the uppermost stream ejection port 803 and the downmost stream ejection port 804) of the print head 211. Further, in a case where four-pass printing is set as the printing mode, the printing medium 300 is conveyed by a distance corresponding to one fourth of the printing width (distance between the uppermost stream ejection port 803 and the downmost stream ejection port 804) of the print head 211. After the completion of the processing at S904, the CPU 201 performs the processing at S905.

At S905, the CPU 201 determines whether or not there is an image that should be printed by the print head 211 continuously after the image printed at immediately previous S904. In a case where there is not an image that should be printed continuously (NO at S905), the CPU 201 performs the processing at S906. On the other hand, in a case where there is an image that should be printed continuously (YES at S905), the CPU 201 performs the processing at S903 again.

For example, in a case where the image printed at immediately previous S904 is the last portion of the first image, the CPU 201 performs the processing at S906. On the other hand, in a case where the image printed at immediately previous S904 is a portion on the way of the first image, the CPU 201 performs the processing at S903 again for performing the next printing scan. It is possible to make the determination such as this based on the contents of the print job and the state of progress of the printing operation in the print head 211.

At S906, the CPU 201 determines whether or not there is a printing area between the print head 211 and the drying unit 213 based on the detection results of the density sensor 214 (not shown schematically in FIG. 9). That is, whether or not part or all of the images formed on the printing medium 300 exist between the print head 211 and the drying unit 213 at the current point in time is determined. In a case where there is not a printing area between the print head 211 and the drying unit 213 (“NO” at S906), the CPU 201 performs the processing at S907. On the other hand, in a case where there is a printing area between the print head 211 and the drying unit 213 (“YES” at S906), the CPU 201 performs the processing at S903 again.

Further, the determination may be made based on the contents of the print job and the state of progress of the printing operation in the print head 211. For example, in a case where the print head 211 is located in the blank area between the first image and the second image and the first image is located between the print head 211 and the drying unit 213, the CPU 201 performs the processing at S903 again. In this case, skip feed is not performed and at next S903, a printing scan not accompanied by the ejection operation is performed. Then, at S904 that is performed subsequently after S903, the conveyance operation corresponding to one band is performed. At S903 in this case, the movement of the carriage may not be performed.

On the other hand, in a case where the print head 211 is located in the blank area between the first image and the second image and the first image is already located on the downstream side of the drying unit 213, the CPU 201 performs the processing at S907. That is, in a case where there is not a printing area between the print head 211 and the drying unit 213, the processing at S907 is performed.

At S907, the CPU 201 determines whether or not skip field can be permitted based on various conditions input via the Menu screen 500 (see FIG. 5). In a case where skip field is permitted (YES at S907), the CPU 201 performs the processing at S908. On the other hand, in a case where skip field is not performed (NO at S907), the CPU 201 performs the processing at S903 again.

For example, in a case where the “Image quality” button 602 (see FIG. 6) is pressed down, it is determined that the execution of skip field is not permitted and the processing at S903 may be performed again. Further, in a case where the type of the printing medium 300 set via the “Paper setting” button 501 is water-fastness paper, a sufficient drying time is necessary to dry the water-fastness paper. Because of this, in a case where printing is being performed for the water-fastness paper, it is determined that the execution of skip field is not permitted and the processing at S903 may be performed again.

At S908, the CPU 201 drives the conveyance unit 210 and performs skip feed for the printing medium 300. For example, in a case where the print head 211 is located in the blank area between the first image area and the second image area, the CPU 201 continuously conveys the printing medium 300 until the initial position of the second image area is located directly under the print head 211. Further, in a case where the print head 211 is located on the upstream side of the second image area and no image exists in the second image area and subsequent image areas, the CPU 201 continuously conveys the printing medium until the last end of the material printed in accordance with the pint job passes the drying unit 213. The conveyance speed at this time is set to a conveyance speed higher than the conveyance speed in a case where the image is printed (that is, the conveyance speed that is averaged in a case where the printing scan at S903 and the conveyance operation at S904 are performed intermittently). After the completion of the processing at S908, the CPU 201 performs the processing at S909.

At S909, the CPU 201 determines whether or not all the print processing in the print job has been completed. In a case where there remains data to be printed (NO at S909), the CPU 201 performs the processing at S903 again and performs the next printing scan. For example, in a case where the initial position of the second image area is conveyed directly under the print head 211 by the skip feed at S908, it is determined that all the print processing in the print job has not been completed at S909. Then, the CPU 201 performs the processing at S903 again in order to perform the first printing scan of the second image. On the other hand, in a case where it is determined that all the print processing has been completed (YES at S909), this flowchart is terminated.

As explained above, in the present embodiment, even in a case where the blank area of the printing medium 300 exists directly under the print head 211, on a condition that the printing area (image) of the printing medium 300 exists between the print head 211 and the drying unit 213, skip feed is not performed. Then, only in a case where all the images formed on the printing medium 300 are located on the downstream side of the drying unit 213 and the blank area of the printing medium 300 exists directly under the print head 211, the execution of skip feed is permitted. According to the configuration such as this, even in a case where the conveyance speed of the printing medium 300 is increased and becomes higher than the normal conveyance speed set in advance during the printing operation (even in a case where skip feed is performed), it is possible to secure the drying time of the image formed on the printing medium 300.

Consequently according to the printing apparatus of the present embodiment, it is possible to improve throughput while securing an appropriate drying time.

### Second Embodiment

In the first embodiment, in a case where an image exists between the print head and the drying unit, the execution of skip field is not permitted. In contrast to this, in the present embodiment, an object is to provide a printing apparatus capable of improving throughput as much as possible even in a case where an image exists between the print head and the drying unit. In the following explanation, explanation of the configuration the same as or corresponding to that of the first embodiment is omitted and different points are explained mainly.

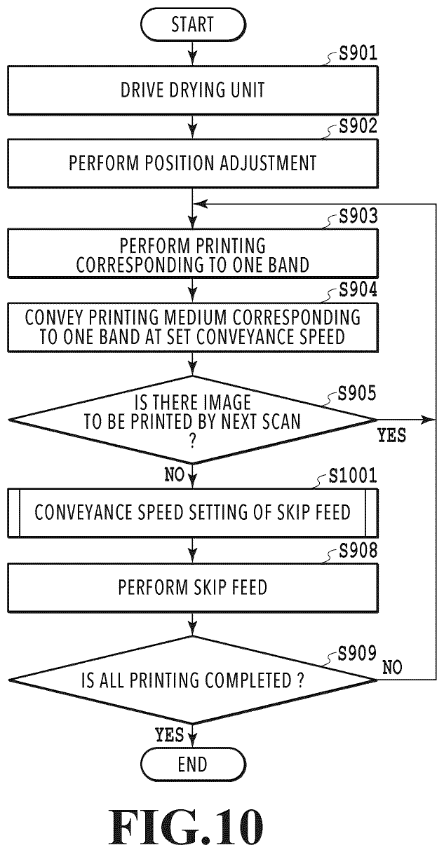

FIG. 10 is a flowchart showing processing that the CPU 201 performs in a case where a print job is input to the printing apparatus of the present embodiment.

As shown in FIG. 10, the present embodiment differs from the first embodiment in that conveyance speed setting processing (S1001) of skip field is performed in place of S906 and S907 shown in FIG. 9. That is, in a case where it is determined that the image printed at immediately previous S903 is the last portion of the first image at S905, the processing at S1001 is performed by the CPU 201.

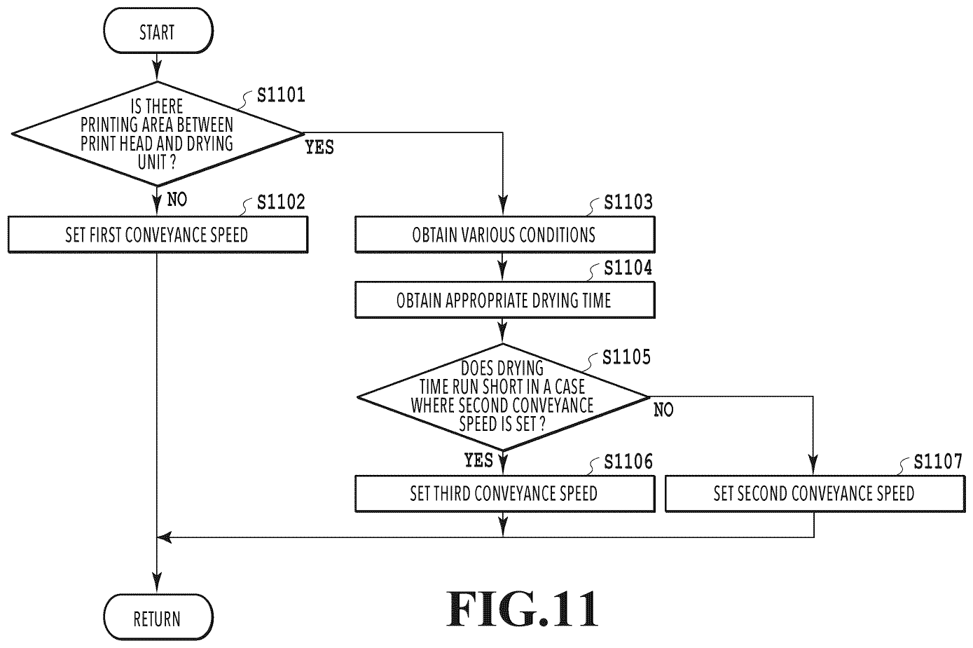

FIG. 11 is a flowchart showing details of the processing at S1001.

At S1101, the CPU 201 determines whether or not there is a printing area between the print head 211 (not shown schematically in FIG. 11) and the drying unit 213 (not shown schematically in FIG. 11) based on the detection results of the density sensor 214 (not shown schematically in FIG. 11). That is, at S1101, the same determination as that at S906 (see FIG. 9) is made. In a case where there is not a printing area between the print head 211 and the drying unit 213 (“NO” at S1101), the CPU 201 performs processing at S1102. On the other hand, in a case where there is a printing area between the print head 211 and the drying unit 213 (“YES” at S906), the CPU 201 performs processing at S1103.

At S1102, the CPU 201 sets a first conveyance speed, which is the highest speed as the speed of skip feed. The reason is that all the images formed on the printing medium 300 are located on the downstream side of the drying unit 213 in this case and the speed of skip feed does not affect the drying time. After the completion of the processing at S1102, skip feed is performed at the first conveyance speed at S908 (see FIG. 10).

At S1103, the CPU 201 obtains various conditions set for the print job. For example, the type of printing medium, the type of ink, the printing mode, the ambient temperature and humidity and the like are obtained, which are input via the Menu screen 500 (see FIG. 5).

At S1104, the CPU 201 obtains a drying time in which it is possible to appropriately dry the printing area of the printing medium 300. Specifically, the CPU 201 refers to the NVRAM 204 and obtains “drying time” corresponding to the various conditions obtained at S1103. Here, “drying time” means a time in which it is possible to appropriately dry the printing area of the printing medium 300. It may also be possible for “drying time” to include the minimum time and the maximum time in which it is possible to appropriately dry the printing area.

At S1105, the CPU 201 determines whether the time that is taken by the printing area to pass the drying unit 213 is shorter than “drying time” obtained at S1102 in a case where skip feed is performed at a second conveyance speed determined in advance. The second conveyance speed is a speed that is adjusted so that it is possible to perform standard drying processing for the printing area of the printing medium 300 and is a speed slower than the first conveyance speed. It may also be possible to find the second conveyance speed by, for example, adding a desired speed “V2” increased by skip feed to a conveyance speed “V1” that is averaged in a case where the printing scan at S903 and the conveyance operation at S904 are performed intermittently. It may also be possible to find the second conveyance speed by dividing a length “X (distance)” in the conveyance direction in the drying unit 213 by a standard drying time “T”.

In a case where “drying time” runs short due to the execution of skip feed at the second conveyance speed (YES at S1105), the CPU 201 performs processing at S1106. On the other hand, in a case where it is possible to secure “drying time” even though skip feed is performed at the second conveyance speed, the CPU 201 performs processing at S1107.

At S1106, the CPU 201 sets a third conveyance speed slower than the second conveyance speed as the speed of skip feed. It is preferable for the third conveyance speed to be set to the speed at which the printing area passes the drying unit 213 in the minimum drying time of “drying time” obtained at S1104. That is, at S1106, the conveyance speed is set, at which it is possible to appropriately dry the printing area of the printing medium 300 in the shortest time. However, the example of the third conveyance speed is not limited to this. At the conveyance speed “V1” described above or higher, it is possible to improve throughput while performing appropriate drying processing. After the completion of the processing at S1106, skip feed is performed at the third conveyance speed at S908 (see FIG. 10).

At S1107, the CPU 201 sets the conveyance speed at the time of skip feed to the second conveyance speed. After the completion of the processing at S1107, skip feed is performed at the second conveyance speed at S908 (see FIG. 10).

As explained above, according to the printing apparatus of the present embodiment, even in a case where there exists an image between the print head and the drying unit, it is permitted to increase the conveyance speed to a conveyance speed higher than the normal conveyance speed (V1). That is, in the present embodiment, even in a case where an image exists between the print head and the drying unit, skip feed is performed. Then, the speed of skip feed in this case is adjusted in accordance with the type of printing medium, the printing mode, the type of ink to be used and the like so that the drying time of the printing area in the printing medium 300 can be secured appropriately.

Consequently according to the printing apparatus of the present embodiment, even in a case where an image exists between the print head and the drying unit, it is possible to improve throughput than that in the first embodiment.

### Third Embodiment

In the present embodiment, an object is to provide a printing apparatus capable of further improving throughput than that in the first and second embodiments. In the first and second embodiments, explanation is given by supposing a case where the printing medium is roll paper, but in the present embodiment, explanation is given by supposing a case where the printing medium is cut paper. In the following explanation, explanation of the configuration the same as or corresponding to that of the first and second embodiments is omitted and different points are explained mainly.

Resulting from the printing medium being cut paper, there is a case where the distance in the conveyance direction from the front end of the cut paper to the printing start position is long. Here, for example, it is assumed that the length in the conveyance direction of the cut paper is three meters and there is a blank area one meter long, which is continuous along the conveyance direction from the front end of the cut paper toward the center. In this case, it is not necessary to perform printing and drying for this blank area.

Consequently, for example, in a case where the position adjustment at S902 (see FIG. 10) is performed, by performing skip feed by an amount corresponding to one meter from the front end of the cut paper, it is possible to improve throughput. It is preferable for the conveyance speed in this case to be a speed equivalent to the first conveyance speed that is set at S1102.

Consequently, according to the printing apparatus of the present embodiment, it is possible to further improve throughput than that in the first and second embodiments. It is possible to adopt the conveyance of the present embodiment in a case where a first print job is printed even for roll paper.

### Fourth Embodiment

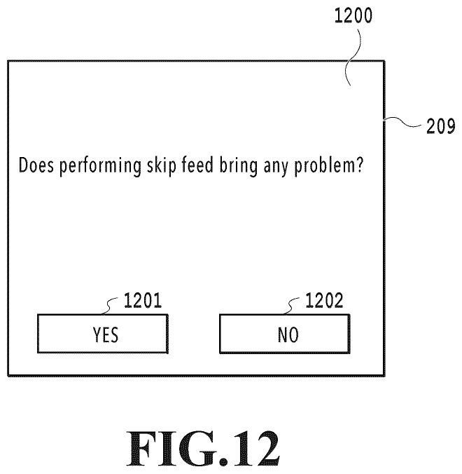

FIG. 12 is a diagram showing one example of a check screen 1200 that can be applied to the present embodiment. The check screen 1200 is displayed on the input/output unit 209 after the completion of the processing at S1106 and S1107 shown in FIG. 11.

As shown in FIG. 12, the check screen 1200 includes an interrogative sentence asking whether or not skip feed may be performed, a “YES” button 1201, and a “NO” button 1202. In a case where the “YES” button 1201 is pressed down, the control of the conveyance unit 210 (not shown schematically in FIG. 12) is performed by the CPU 201 (not shown schematically in FIG. 12) so that performing skip feed is permitted. On the other hand, in a case where the “NO” button 1202 is pressed down, the control of the conveyance unit 210 is performed by the CPU 201 so that performing skip feed is not permitted.

According to the configuration such as this, even in a case where the second conveyance speed or the third conveyance speed is set temporarily, skip feed is performed after the check by a user, and therefore, the drying time becomes more likely to be set appropriately. The timing at which the check screen 1200 disappears from the input/output unit 209 is not limited particularly. For example, control may be performed so that the check screen 1200 is displayed while skip feed is being performed and after the completion of skip feed, the check screen 1200 is turned off.

Further, in a case where skip feed is performed after all the printing areas pass the drying unit 213 (not shown schematically in FIG. 12), a guide sentence to the effect that skip feed is performed may be displayed on the input/output unit 209. In this case, skip feed may be performed without obtaining consent of a user. The reason is that the printing for the printing medium 300 has been completed at this timing, and therefore, there remain only blank areas for which it is not necessary to perform printing on the printing surface of the printing medium 300.

### Other Embodiments

In the above embodiments, the so-called serial print head is used, which reciprocates in the scanning direction. However, it is also possible to apply the technique of the present disclosure to a so-called full-line printing apparatus, in which a print head having nozzles located across the entire area in the width direction (X-direction) of a printing medium is provided in an extended manner.

In a case of the full-line printing apparatus, the print head performs printing for the printing medium 300 in the state where the position relative to the printing medium 300 is fixed. In the full-line printing apparatus, the conveyance during the printing operation is continuous conveyance, not intermittent conveyance and this conveyance speed is set in accordance with the drive frequency of the print head and the like. Then, in a case where the blank area of the image is located at the position of the print head, as in the above-described embodiments, it is possible to perform skip feed for the printing medium at a higher speed up to the initial position of the next image.

That is, in the full-line printing apparatus also, as in the first embodiment, in accordance with whether or not the printing area exists between the print head and the drying unit, whether or not to perform skip feed may be determined. Further, as in the second embodiment, in accordance with whether or not the printing area exists between the print head and the drying unit, the conveyance speed of skip feed may be changed.

Further, it is also possible to apply the technique of the present disclosure to a multi-function peripheral apparatus (MFP) in which the scan function, the FAX function, the transmission function and the like are integrated provided that the apparatus comprises the printing function.

Further, in the above embodiments, the contactless drying unit using drying air that is generated by combining the blower fan and the coil-type heater. However, the example of the drying unit to which the technique of the present disclosure can be applied is not limited to this. It may also be possible to use a contact heater, a heater utilizing radiant heat or the like as the drying unit.

Further, in a case where the processing at S1106 and S1107 in FIG. 11 is performed in the situation in which the water-fastness paper is set via the “Paper setting” button 501, the CPU 201 may set a conveyance speed so as to become slower than the conveyance speed in a case where another piece of paper with less water fastness is set. The reason is that the water-fastness paper is harder to absorb ink than other pieces of paper, and therefore, it is necessary to secure a sufficient drying time.

Further, in a case where the processing at S1106 and S1107 in FIG. 11 is performed in the situation in which the “Image quality” button 602 is pressed down, the CPU 201 may set the conveyance speed so as to become slower than the conveyance speed in a case where the printing quality giving priority to speed over image quality is set.

Further, in the above embodiments, ink droplets are ejected by causing film boiling to occur by the heating element, but the method of ejecting ink droplets is not limited to this. It is also possible to apply the technique of the present disclosure to the print head adopting the method of ejecting liquid inside the print head by deforming the piezoelectric element.

In the above embodiments, ink is used as liquid, but the ink that can be used for the technique of the present disclosure is not limited to ink. Other than ink, as liquid, it is possible to use various printing liquids including a processing liquid that is used for the purpose of improving the fixing property of ink in a printing medium, reducing gloss unevenness, and improving scratch resistance.

According to the printing apparatus of the present disclosure, it is possible to improve throughput while securing an appropriate drying time.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-008572, filed Jan. 24, 2024 which are hereby incorporated by reference wherein in its entirety.

What is claimed is:

1. A printing apparatus comprising:
a conveyance unit configured to convey a printing medium in a conveyance direction;
a printing unit configured to print an image by appending liquid to a printing medium to be conveyed by the conveyance unit;
a drying unit provided on the downstream side of the printing unit in a conveyance path of a printing medium and configured to dry liquid appended by the printing unit; and
a control unit configured to alternately perform an operation to cause the conveyance unit to convey a printing medium at a predetermined conveyance speed and an operation to cause the printing unit to perform printing, wherein
in a case where an area in which it is not necessary to perform printing of a printing medium is located at a position at which the printing unit can perform printing:
on a condition that an image printed by the printing unit does not exist between the drying unit and the printing unit, the control unit performs first control to cause the conveyance unit to convey a printing medium at a first conveyance speed higher than the predetermined conveyance speed; and
on a condition that an image printed by the printing unit exists between the drying unit and the printing unit, the control unit performs second control to cause the conveyance unit to convey a printing medium at a second conveyance speed slower than the first conveyance speed.

2. The printing apparatus according to claim 1, wherein
the second conveyance speed is equal to the predetermined conveyance speed.

3. The printing apparatus according to claim 1, wherein
the second conveyance speed is higher than the predetermined conveyance speed.

4. The printing apparatus according to claim 3, wherein
the second conveyance speed is at speed at which time necessary for an image printed by the printing unit to pass the drying unit is a drying time set in advance, which is appropriate to dry the image.

5. The printing apparatus according to claim 4, further comprising:
a setting unit configured to set the drying time based on printing conditions including at least one of type of printing medium, type of liquid, printing quality, environmental temperature, and environmental humidity, wherein the control unit sets the second conveyance speed based on the drying time set by the setting unit.

6. The printing apparatus according to claim 5, further comprising:
an input unit for a user to input at least part of the printing conditions.

7. The printing apparatus according to claim 5, further comprising:
a storage unit configured to store the printing conditions and the drying time in association with each other, wherein
the setting unit sets the drying time corresponding to the printing conditions by referring to the storage unit.

8. The printing apparatus according to claim 7, wherein
the drying time includes a minimum time and a maximum time appropriate to dry the image.

9. The printing apparatus according to claim 5, wherein
in a case where printing quality giving priority to image quality over speed is set by the setting unit, the control unit sets the second conveyance speed so as to become slower than that in a case where printing quality giving priority to speed over image quality is set.

10. The printing apparatus according to claim 5, wherein
in a case where a medium whose water fastness is high is set as a printing medium by the setting unit, the control unit sets the second conveyance speed so as to become slower than that in a case where a medium whose water fastness is low is set.

11. The printing apparatus according to claim 1, further comprising:
a housing unit configured to house a continuous paper as the printing medium.

12. The printing apparatus according to claim 1, further comprising:
a housing unit configured to house a cut paper as the printing medium.

13. The printing apparatus according to claim 1, further comprising:
a display unit configured to display a screen on which to check whether or not to convey a printing medium at the first conveyance speed.

14. The printing apparatus according to claim 1, wherein
the printing apparatus is a serial printing apparatus printing an image by appending liquid to a printing medium while the printing unit moves in a direction intersecting a conveyance direction.

15. The printing apparatus according to claim 1, further comprising:
a detection unit configured to detect density of a printing medium between the drying unit and the printing unit, wherein
the control unit determines whether or not the image exists between the drying unit and the printing unit based on detection results of the detection unit.

16. A control method of a printing apparatus including a conveyance unit configured to convey a printing medium in a conveyance direction, a printing unit configured to print an image by appending liquid to a printing medium to be conveyed by the conveyance unit, and a drying unit provided on the downstream side of the printing unit in a conveyance path of a printing medium and configured to dry liquid appended by the printing unit, the method comprising:
causing the conveyance unit to convey a printing medium at a predetermined conveyance speed and causing the printing unit to perform printing are performed alternately; and
in a case where an area in which it is not necessary to perform printing of a printing medium is located at a position at which the printing unit can perform printing:
on a condition that an image printed by the printing unit does not exist between the drying unit and the printing unit, the conveyance unit is caused to convey a printing medium at a first conveyance speed higher than the predetermined conveyance speed; and
on a condition that an image printed by the printing unit exists between the drying unit and the printing unit, the conveyance unit is caused to convey a printing medium at a second conveyance speed slower than the first conveyance speed.

17. A non-transitory computer readable storage medium storing instruction for causing a computer to execute a control method of a printing apparatus including a conveyance unit configured to convey a printing medium in a conveyance direction, a printing unit configured to print an image by appending liquid to a printing medium to be conveyed by the conveyance unit, and a drying unit provided on the downstream side of the printing unit in a conveyance path of a printing medium and configured to dry liquid appended by the printing unit, the method comprising:
causing the conveyance unit to convey a printing medium at a predetermined conveyance speed and causing the printing unit to perform printing are performed alternately; and
in a case where an area in which it is not necessary to perform printing of a printing medium is located at a position at which the printing unit can perform printing:
on a condition that an image printed by the printing unit does not exist between the drying unit and the printing unit, the conveyance unit is caused to convey a printing medium at a first conveyance speed higher than the predetermined conveyance speed; and
on a condition that an image printed by the printing unit exists between the drying unit and the printing unit, the conveyance unit is caused to convey a printing medium at a second conveyance speed slower than the first conveyance speed.
